(19) United States
(12) Patent Application Publication
(10) Pub. No.: US 2018/0376520 A1
(43) Pub. Date: Dec. 27, 2018

(54) PAUSE PRESENTATION OPTION FOR PEER-TO-PEER WIRELESS SESSIONS

(71) Applicant: Microsoft Technology Licensing, LLC, Redmond, WA (US)

(72) Inventors: Sunil Pai, Seattle, WA (US); Uday Hegde, Redmond, WA (US)

(73) Assignee: Microsoft Technology Licensing, LLC, Redmond, WA (US)

(21) Appl. No.: 15/634,937

(22) Filed: Jun. 27, 2017

(51) Int. Cl. H04W 76/04; H04L 29/08; H04W 76/02

(52) U.S. Cl. CPC H04W 76/043; H04L 67/145; H04W 76/023; H04L 67/1053

(57) ABSTRACT

Various technologies are described for modifying peer-to-peer sessions over a wireless network connection. In particular embodiments, a “pause” functionality is provided that allows a peer-to-peer session (such as a Miracast session) to be paused. In some embodiments, the session is paused for a user-selected selected period of time. In other embodiments, the session is paused until a resume message is received from the source device. In particular implementations, the pause functionality allows the source device to be used for another purpose during the period in which the session is paused and/or allows the source device to be removed from the range of the sink device.

### FIELD

This application concerns technologies for modifying peer-to-peer sessions over a wireless network connection. In particular embodiments, a “pause” functionality is provided that allows a peer-to-peer session (such as a Miracast session) to be paused.

### BACKGROUND

Miracast is a peer-to-peer wireless standard used for displaying content from a phone, PC, or other computing device to another device (typically, a TV or a projector) without the need for cables to provide the connection. For example, a presenter may use Miracast (or other peer-to-peer or proprietary connection) to display a presentation from a local source device (e.g., a tablet or laptop) to a sink device (e.g., a display device that is Miracast enabled or that has a Miracast or other suitable peer-to-peer dongle coupled to the display device).

By default, when one connects a source device to the sink device, the presentation is initiated in “duplicate mode”. In duplicate mode, the content displayed on the local source device is transmitted to the sink device for presentation (thus “duplicating” the displays of the two devices). During the presentation, however, the presenter may need to pause the presentation to interface with or access local content on the source device. For example, the presenter may be interrupted by a question or request that requires access to email or other information that is outside the current application or display screen. To do this, the presenter typically has to perform a series of laborious and computationally intensive procedures (e.g., changing the presentation mode (to “extend” for example), moving the current presentation to a second screen, and then interfacing with the primary screen to select and view the sensitive information).

Further, it is not uncommon for a Miracast connection between the source and destination to be dropped at times when it is unintended (e.g., the presenter leaves the room for a moment). This is because the underlying wireless link has to be kept active at all times. According to the Miracast specification, such linkage is maintained using a “keep alive” function in which the source device transmits a “keep alive” request message at fixed time intervals and the sink device transmits a “keep alive” response message to the source device in response to the request message. See, e.g., Section 6.5.1 of the Wi-Fi Display Technical Specification, Version 2.0. If the source device does not receive the response after a selected time period (the timeout period), the source device is expected to abort the peer-to-peer session. Likewise, if the sink device does not receive a request after the selected time period, the sink device is expected to abort the peer-to-peer session.

The disclosed technology addresses these issues by providing tools, techniques, and user interfaces for providing various pause functions for use in peer-to-peer scenarios.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In this disclosure, various technologies are described for modifying peer-to-peer sessions over a wireless network connection. In particular embodiments, a “pause” functionality is provided that allows a peer-to-peer session (such as a Miracast session) to be paused. The session can be paused for a user-selected period of time, or until a resume message is received from the source device. In particular implementations, the pause functionality allows the source device to be used for another purpose during the period in which the session is paused and/or allows the source device to be removed from the range of the sink device

In one example embodiment, a Miracast peer-to-peer wireless network connection is established between a source computing device and a sink computing device. A stream is established over the Miracast peer-to-peer wireless network connection for streaming audio, video, or audio-video data from the source computing device to the sink computing device. A request is received from the source computing device for the sink computing device to enter a pause state. Based on the received request, the sink device enters a pause state that includes suspending output of the stream. For example, based on the received request, the source device's Miracast endpoint pauses sending a video stream and the sink device pauses refreshing its display endpoint while continuing to display the last frame before the pause.

In another example embodiment, a peer-to-peer wireless network connection is established between a source computing device and a sink computing device. A stream is established over the peer-to-peer wireless network connection for streaming audio, video, or audio-video data from the source computing device to the sink computing device. A request is received from the source computing device for the sink computing device to enter a pause state. Based on the received request, a pause state is entered that includes suspending output of the stream, and the pause state is maintained despite the absence of any packets coming from the source computing device to indicate the presence of the source computing device in a local peer-to-peer range of the sink computing device.

In yet another embodiment, a peer-to-peer wireless session is established with a sink computing device, a user interface is displayed that allows a user to pause the peer-to-peer wireless session, and an instruction to pause the peer-to-peer wireless session is transmitted to the sink computing device based on input from the user received from the user interface.

Various technical advantages can be realized by implementing the disclosed embodiments of the disclosed technology. For example, the use of the “pause” function can save bandwidth, power, and computational resources during the time in which the function is invoked, as the content data from the source device need not be sent to the sink device. For instance, power can be saved at either or both of the source or sink devices by reducing the unnecessary network payload that would otherwise occur during the pause state. Further, bandwidth and computational resources are saved by allowing for the absence of the “keep alive” signal exchange between the source device and the sink device and/or saving computational resources that would otherwise be necessary to re-establish the peer-to-peer connection if the source device is moved out of range of the sink device and then returned.

As described herein, a variety of other features and elements can be incorporated into the technologies separately and/or in combination.

### BRIEF DESCRIPTION OF THE DRAWINGS

FIG. 1 is a schematic block diagram depicting an example peer-to-peer wireless network connection between two computing devices.

FIG. 2 is a schematic block diagram depicting an example user interface for invoking a pause function in accordance with the disclosed technology.

FIG. 3 is a schematic block diagram depicting an example user interface for setting parameters for the pause function in accordance with the disclosed technology.

FIG. 4 is a block diagram of an example flow for pausing a peer-to-peer session for a period of time.

FIG. 5 is a block diagram of an example flow for pausing a peer-to-peer session until selected to be resumed.

FIG. 6 is a block diagram of an example flow for pausing a peer-to-peer session until being overridden by the source device or an administrator's device.

FIG. 7 is a flow chart of an example method for implementing aspects of the disclosed technology.

FIG. 8 is a flow chart of another example method for implementing aspects of the disclosed technology.

FIG. 9 is a flow chart of another example method for implementing aspects of the disclosed technology.

FIG. 10 is a diagram of an example computing system in which some described embodiments can be implemented.

FIG. 11 is an example mobile device that can be used in conjunction with the technologies described herein.

### DETAILED DESCRIPTION

### I. General Considerations

Disclosed below are representative embodiments of methods, apparatus, and systems for providing “pause” functionality for use in a peer-to-peer session (e.g., a video or audio session in which video or audio is broadcast from a source device to a sink device). For illustrative purposes, the description will refer to a Miracast session. It should be understood, however, that this usage scenario is by way of example only, as the technology can be used in other peer-to-peer broadcasting scenarios as well.

The disclosed methods, apparatus, and systems should not be construed as limiting in any way. Instead, the present disclosure is directed toward all novel and nonobvious features and aspects of the various disclosed embodiments, alone or in various combinations and subcombinations with one another. Furthermore, any features or aspects of the disclosed embodiments can be used in various combinations and subcombinations with one another. For example, one or more method acts from one embodiment can be used with one or more method acts from another embodiment and vice versa. The disclosed methods, apparatus, and systems are not limited to any specific aspect or feature or combination thereof, nor do the disclosed embodiments require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the figures may not show the various ways in which the disclosed methods can be used in conjunction with other methods.

Various alternatives to the examples described herein are possible. For example, some of the methods described herein can be altered by changing the ordering of the method acts described, by splitting, repeating, or omitting certain method acts, etc. The various aspects of the disclosed technology can be used in combination or separately. Different embodiments use one or more of the described innovations. Some of the innovations described herein address one or more of the problems noted in the background. Typically, a given technique/tool does not solve all such problems.

As used in this application and in the claims, the singular forms “a,” “an,” and “the” include the plural forms unless the context clearly dictates otherwise. Additionally, the term “includes” means “comprises.” Further, as used herein, the term “and/or” means any one item or combination of any items in the phrase.

### II. Detailed Embodiments of the Disclosed Technology

As described herein, various technologies are described for modifying peer-to-peer sessions over a wireless network connection. The peer-to-peer wireless network connection is established between a first computing device (e.g., acting as a source device, such as a Miracast source device) and a second computing device (e.g., acting as a sink device, such as a Miracast sink device). The peer-to-peer wireless network connection established between the first and second computing devices supports a data channel (also called a stream or path) for communicating data between the first and second computing devices. For example, with a Miracast peer-to-peer wireless network connection, the data channel is a Miracast channel for streaming audio-video data (e.g., for remote streaming of audio and/or video content from the first computing device to a display associated with the second computing device).

Example technologies described herein support the pausing (or suspending) of the session and allow for the source device to be out-of-range from the sink device without terminating the session.

A. Example Peer-to-Peer Environments

In example embodiments of the disclosed technology, a peer-to-peer wireless network connection can be established between computing devices to allow information broadcast from a first device (the “source device”) to be received and displayed by a second device (the “sink device”). The information can be, for example, an image, a video stream, an audio stream, or an audio-video stream.

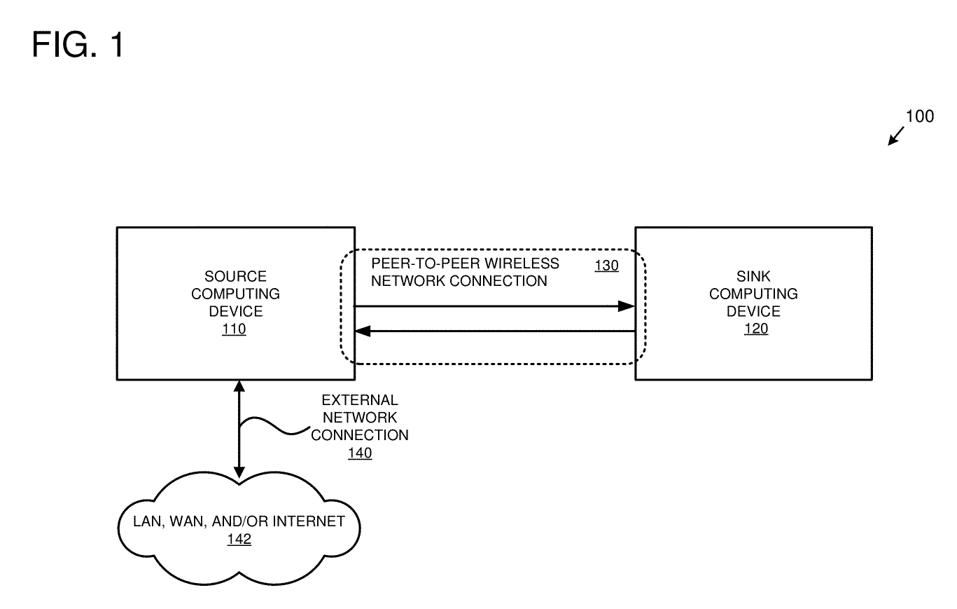

FIG. 1 is a diagram 100 depicting an example peer-to-peer wireless network connection between two computing devices. The devices in diagram 100 can be configured to implement any of the disclosed embodiments for pausing a peer-to-peer session (e.g., a Miracast session). In the diagram 100, a source computing device 110 is connected to a sink computing device 120 via a peer-to-peer wireless network connection 130 (e.g., a Miracast session). The source computing device 110 can be any type of computing device, such as a laptop, tablet, smart phone, personal computer, etc. The source computing device 110 supports the peer-to-peer wireless network connection 130 via a wireless network interface (e.g., Wi-Fi, Wi-Gig, Bluetooth, or another type of wireless technology supporting peer-to-peer wireless network connections). The wireless network interface can comprise one or more transceivers configured to communicate using the connection 130.

The source computing device 110 can also support an external network connection 140 via a network interface. The network interface connecting to the external network connection 140 can be a wireless network interface (e.g., the same Wi-Fi or Wi-Gig network interface that supports the peer-to-peer wireless network connection 130 or a different wireless network interface, such as a cellular network connection or another Wi-Fi or Wi-Gig connection) or a wired network interface (e.g., an Ethernet connection).

The external network connection 140 allows the source computing device 110 to communicate with external networks (other than the peer-to-peer wireless network connection 130), such as local-area networks (e.g., computing devices on a local network of a home or business), wide-area networks (e.g., remote computing devices accessible via network connections to remote locations), and/or the Internet 142 (e.g., via networking devices such as routers or gateways that connect to an Internet service provider).

The sink computing device 120 is a computing device that is connected to the peer-to-peer wireless network connection 130. The sink computing device 120 can be a remote display dongle or a computing device with built-in remote display technology for receiving remotely streamed audio and/or video content from the source computing device 110. In some implementations, the sink computing device 120 is a Miracast device (e.g., a Miracast dongle attached to a display, such as a television, or a Miracast enabled computing device such as a display with built-in Miracast technology). The sink computing device 120 may have other network interfaces or may have one network interface that only supports the peer-to-peer wireless network connection 130.

The sink computing device 120 performs operations to establish and communicate over a data channel supported by the peer-to-peer wireless network connection 130 (e.g., via a software and/or firmware component of the second computing device 120). For example, the sink computing device 120 can receive a request from the source computing device 110 to establish the peer-to-peer wireless network connection 130 via the data channel (e.g., using Miracast or another peer-to-peer wireless protocol). The sink computing device 120 can then receive data from the source computing device and present it from the sink computing device. For instance, the data can be video and/or audio content that is displayed on a display or screen of the second computing device 120 and/or that is output from speakers of the second computing device 120.

B. Example “Pause” Functionalities

The example environments of FIG. 1 illustrate a peer-to-peer wireless network connection that can be established between a source computing device and a sink computing device (e.g., using a Miracast connection). This section describes how the source and sink computing devices (e.g., source computing device 110 and sink computing device 120) can implement a “pause” feature that allows content from a current session to be paused in the session. “Pausing”, in this context, includes both (a) freezing (or suspending) a display or other output of a session whereby the sink device enters a state in which the currently presented content is repeated (e.g., a video frame or image frame at the sink device is continuously displayed until the pause event expires or is otherwise terminated) and (b) temporarily entering a black-out state or other pause state where the current content is ceased and replaced by other content (such as a pause screen (which may include animations), a white screen, and/or an alteration in the audio (including silence or default audio (e.g., music)) until the pause event expires or is otherwise terminated.

In certain embodiments, and after peer-to-peer wireless network connection (e.g., connection 130, such as a Miracast connection) is established, the source device 110 and the sink device 120 can implement a “pause” function as introduced above. The pause functionality can be implemented: (a) for a fixed period of time; (b) until receipt of a “resume” communication from the same source; (c) until receipt of an “override” communication from the same source; and/or (d) until receipt of an “override” communication from another authorized source (e.g., from a device operated by a network administrator).

In certain embodiments, during the time the sink device is operating in the “pause” mode, it ignores the absence of the expected “keep-alive” signal, which would otherwise be expected and used to determine that the source is absent such that the connection is dropped after the corresponding timeout period expires. Thus, in such embodiments, the disclosed technology includes deviations from standardized peer-to-peer communication models, including the Miracast specification, that require periodic “keep-alive” signals in order to maintain a peer-to-peer session.

Such “pause” functionality can be used in a variety of usage scenarios. For instance, a presenter can pause a presentation at a point in time, navigate to confidential or other not-to-be-presented information on her source device (or leave the room and become out of range of the sink device), and then, when ready, resume the presentation. Another usage scenario is where a peer-to-peer wireless connection is established to control one or more monitors that are to display a static image for some period but that is updated periodically. For instance, many restaurants, retail outlets, building operators, and/or organizations display information on display devices that is primarily static but is updated from time to time (e.g., menus, available retail items, advertisements, daily schedules, or such types of information). Using the “pause” functionality as disclosed herein, a peer-to-peer wireless connection (such as a Miracast connection) can be used to provide such functionality in a manner that is resource, bandwidth, and power efficient.

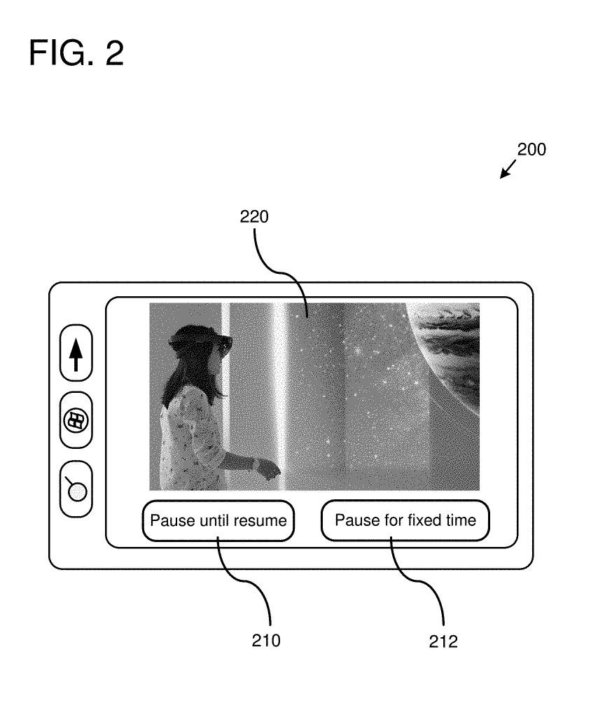

In practice, the option to “pause” a peer-to-peer session (e.g., a Miracast session) can be presented to a user of the source device via a graphic user interface. FIG. 2 is a schematic block diagram 200 showing an example graphical user interface in which the user has invoked a “pause” option (e.g., by swiping upward from the currently presenting content, or selecting pause from another menu or selection facility). In the example embodiment, the user is presented with one or more of: (a) an option 210 to pause the session until the user of the source device desires to resume the session; or (b) an option 212 to pause the session for a period of time. Also shown in the example diagram 200 is the current image 220 being displayed on the source device.

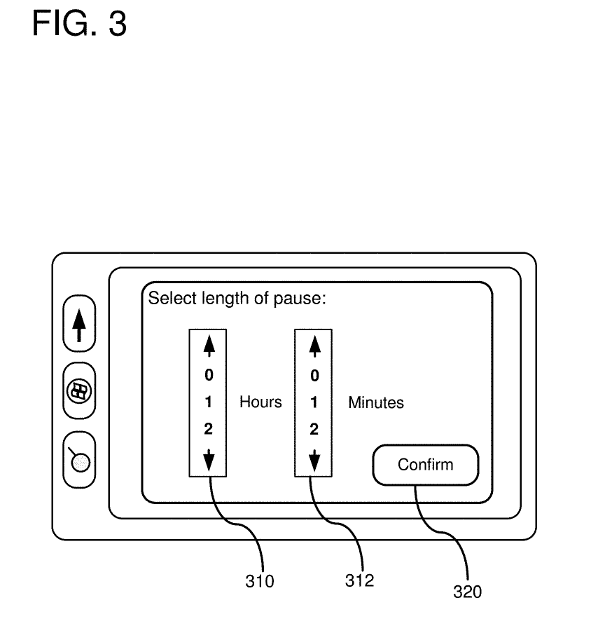

In certain example embodiments, if the option 212 is invoked (pausing for a period of time), the source device can display a graphic user interface in which the amount of time for the pause is selectable by a user. An example of such an interface 300 is shown in FIG. 3, which shows a selectable range 310 for selecting a number of hours for the pause and a selectable range 312 for selecting a number of minutes for the pause. The interface 300 also includes a confirmation button 320 to approve the selected time period.

Once the time period has been selected and confirmed, the source device can send a message or communication to the sink device including instructions for entering the pause state for the selected amount of time. In response, the sink device can start a timer or mark the time at which the communication is received so that the sink can determine when the fixed time period has expired. As noted, the “pause” state can include repeating the current image at the sink device until the pause period expires. Further, in the “pause” state and in certain embodiments, the sink device deviates from the Miracast standard and stops requiring that a “keep alive” signal be received from the source device in order to continue the session. In other words, the sink device ignores the absence of the “keep alive” signal, thus allowing the source device to leave the direct communication range of the sink device. In certain embodiments, the sink device continues to periodically send a signal to broadcast its presence but is only available to establish a connection with either the original source device or an administrator device. For example, the sink device could stay frozen on the last frame displayed before the pause took effect. The source could then restart sending data once the session is resumed (e.g., after the pause time period has expired, or after a user of the source reconnects with the sink and manually resumes the session). For instance, the sink could have a timer of its own that, once expired, would check if the session has resumed. If the session has not resumed, the sink can then assume that something went wrong and reset its state to be available for a new session thereafter.

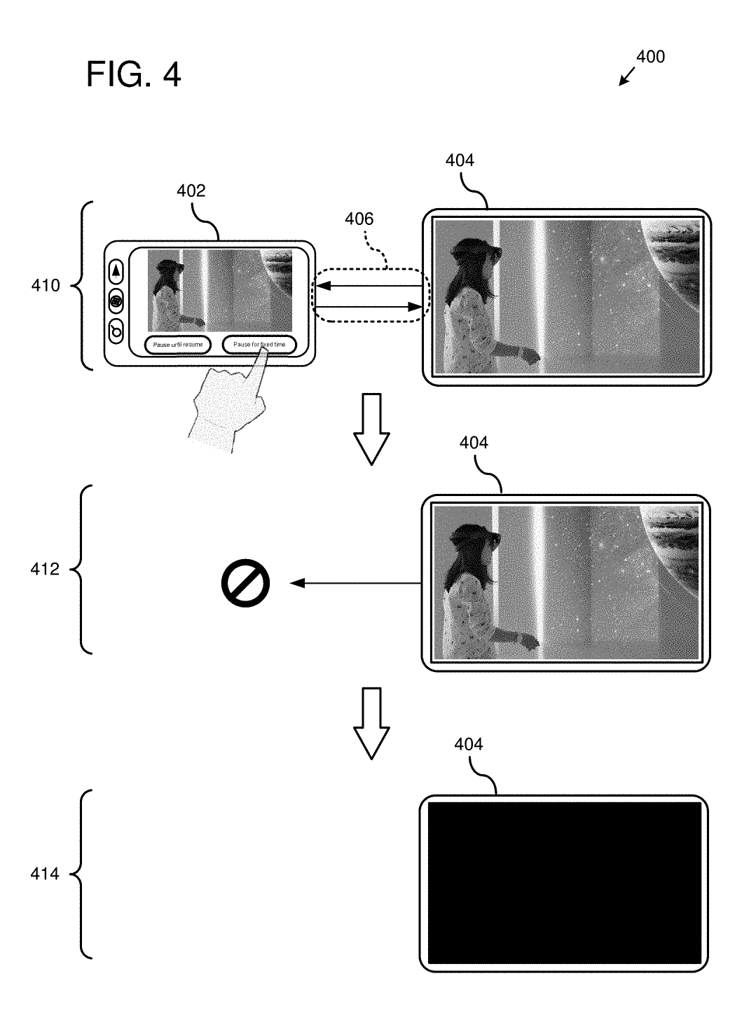

FIG. 4 is a schematic block diagram 400 depicting an example operation of the pause-for-a-period-of-time functionality between a source device 402 and a sink device 404. In the illustrated example, at 410, the source device 402 and the sink device 404 are illustrated in an active peer-to-peer wireless session, illustrated by connection 406. At 410, a user of the source device 402 selects the pause functionality and further selects to pause for a fixed time (e.g., via a user interface, such as those shown in FIGS. 2 and/or 3). At 412, the sink device 404 continues displaying the image from the peer-to-peer session, even though the source device 402 may be absent from the range of the sink device 404 (e.g., the source device may be beyond the range for maintaining a Miracast session). In this example, the sink device 404 continues displaying the image at the time of receipt of the “pause” instruction until expiration of the selected time period. At 414, the selected time period expires, and the sink device 404 discontinues the presentation (e.g., display or other output) of the content that was paused.

In some embodiments, when the sink has been instructed to “pause” for a period of time, the sink need not send periodic “keep alive” signals since the source device might roam out of range. The sink device can resume “keep alive” signals after the time period has expired. Then, when the source device returns, it can reconnect to the sink device (e.g., the source device knows the sink's address, so reconnection can occur quickly). The sink device can then wait for further instructions from the source device.

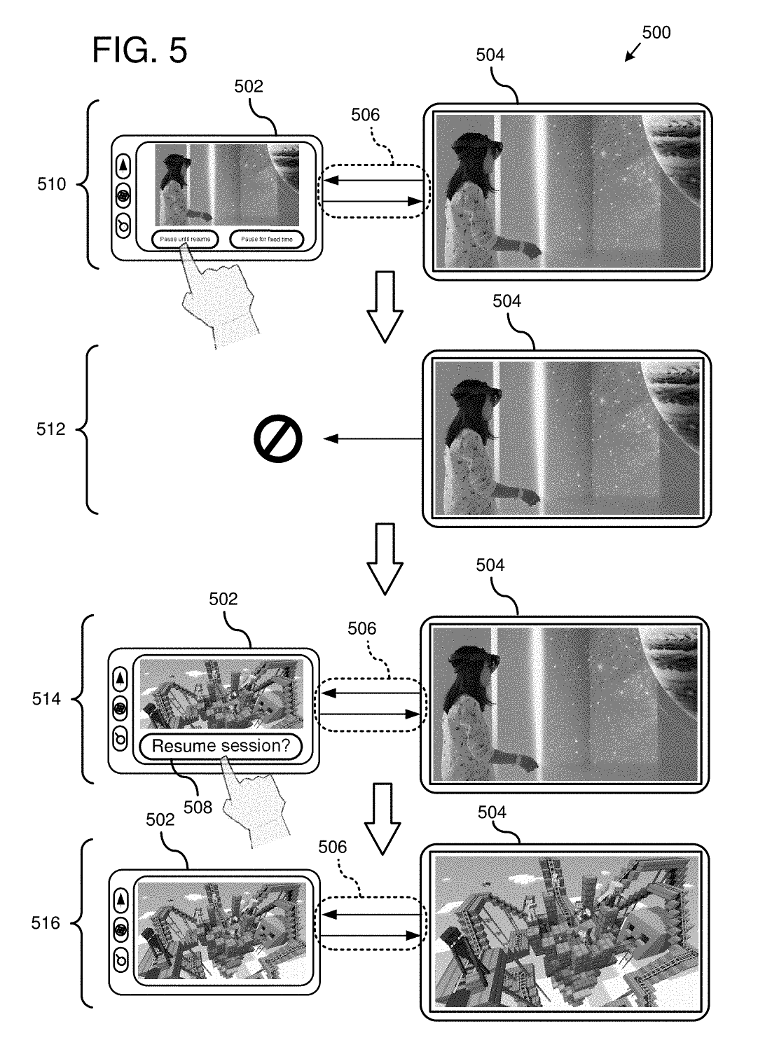

FIG. 5 is a schematic block diagram 500 depicting an example operation of the pause-until-resume functionality between a source device 502 and a sink device 504. In the illustrated example, at 510, the source device 502 and the sink device 504 are illustrated in an active peer-to-peer wireless session, shown by connection 506. At 510, a user of the source device 502 selects the pause functionality and further selects to pause until the source device indicates to resume (e.g., via a user interface, such as the one shown in FIG. 2). At 512, the sink device 504 continues displaying the image from the peer-to-peer session until a resume instruction is received from the source device 502. In some embodiments, then, the source device 502 can remain in range and connected to the sink device 504 or be moved out of range and not be connected to the sink device 504 (e.g., the source device can exit the peer-to-peer connection range (such as the Miracast range) of the sink device 504). For instance, in a first example scenario, the source device 502 can remain in the range of the sink device 504, but still remain in a pause state until the resume instruction is sent (thus allowing the user of the source device 502 to be used for another purpose during the pause state). Or, in a second example, the source device 502 can be moved outside of the range of the sink device 504 without interrupting the pause state and without the need for exchanging “keep alive” signals to maintain the session. At 514, the source device 502 either reestablishes its connection with the sink device 504 or continues its connection with the sink device 504 and sends a message to resume the session. Further, in the scenario where the source device reestablishes the connection, many of the initial authentication communications can be skipped because the two devices have saved information about each other (e.g., what channel is preferred, who is going to be the source device, etc.), thus allowing the reconnection to occur more quickly. Further, the device discovery process (which often requires manual input to select a device from a list of available devices) can be avoided. The resume message can be transmitted from the source device 502 in response to a user selecting to resume the session via a button displayed on a user interface (such as “resume session” button 508). When the message is received, the content form the source device 502 is streamed to and presented at the sink device 504. This continuation and/or resumption of the peer-to-peer connection is illustrated at 516, where the sink device 504 displays the content broadcast from the source device 502.

In certain embodiments, the “resume” signal is required to come from the same source device that invoked the function (e.g., either in the same session as when the function was invoked, or in a different, later established, session with the source device).

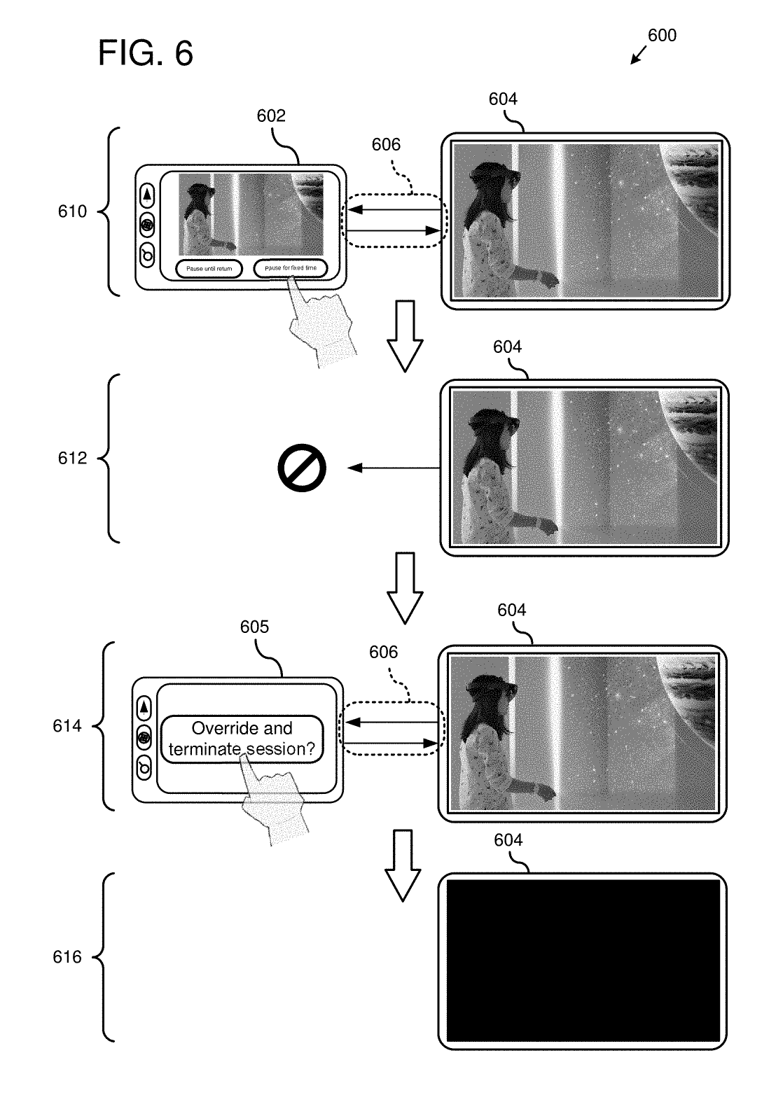

FIG. 6 is a schematic block diagram 600 depicting an example operation of the pause-until-override functionality between a source device 602 and a sink device 604. In the illustrated example, at 610, the source device 602 and the sink device 604 are illustrated in an active peer-to-peer wireless session, shown by connection 606. At 610, a user of the source device 602 selects the pause functionality and further selects to pause for a fixed amount of time, as explained above with respect to FIG. 4. Alternatively, the user of the source device 602 could select to pause until the user elects to resume as in FIG. 5. At 612, the sink device 604 continues displaying the image from the peer-to-peer wireless session until the selected time expires. As above, the source device 602 can remain in range or be moved out of range of the sink device 604. At 614, a device 605 connects with the sink device 604 and sends an “override” signal that serves to override any instructions for pausing the presentation at the sink device 604, thereby terminating the paused display at the sink device 604. The override message can be transmitted in response to a user selecting to override the session via a button displayed on a user interface (such as “override and terminate session” button 608). The device 605 can be either the original source device or can be a device operated by an administrator. For example, the communication protocol for the sink device 604 can include an operation that recognizes certain devices as being administrator devices (e.g., based on a device ID transmitted by the source device, an exchange of a login name and password, an authorization number or password). Once connected with the sink device 604, the device 605 can send an instruction to terminate the paused session, thus causing the sink device to cease presenting the paused content. This cessation is depicted at 616, which shows a black screen, but the response can be a variety of responses (e.g., displaying a blank screen, displaying an administrator menu, displaying a “home” screen, or displaying another screen).

In further embodiments, a physical override feature is included on the sink itself, either as a supplement to the override functionality described above or as an alternative to such alternative. For example, the sink device itself can include a “reset” button or could include a separate remote device for controlling the sink device that could include a “reset” feature/button.

In some embodiments, the override functionality may be selectively enabled or disabled. For instance, at the time of establishing the peer-to-peer wireless session, a user of the source device can select to either enable or disable such override functionality. In instances where the override functionality is disabled, the possibility for a sink device to be overridden during the pause period is disabled (although in some implementations, the sink device can still be overridden by the original source device). In certain embodiments, if the override functionality is enabled, the sink can either be overridden by an administrator's device (as described above) or, alternatively, by any source device in peer-to-peer communication range with the sink device. In the latter instance, the sink device drops the first source device and lets the second source device take over.

In certain embodiments of the disclosed technology, the pause functionality can be automatically invoked by the source device. For example, the peer-to-peer wireless stream can be monitored at the source device and a procedure can be performed that detects that the image content being streamed has not changed for some period of time (e.g., 5 seconds, 10 seconds, 30 seconds, or any other time period). Upon detecting that the streamed content has been static, the source device can automatically send an instruction to the sink device to pause until a resume signal is transmitted. The source device can continue monitoring the content at the source device, and when it changes, the source device can transmit the resume signal and reestablish the stream. In this way, the pause functionality described herein can be adaptively invoked in an automatic manner by the source device. Such content-adaptive pausing implementations save power, computational resources, and network resources.

In an alternative embodiment, the peer-to-peer wireless connection can be controlled by a program for presenting a slide presentation. Because slides are generally static, the pause functionality can be automatically invoked after a new (or next) slide is broadcast to the sink device. The stream can then be resumed when the user of the source device select to advance to the next slide. Thus, the context of the presentation (e.g., a slide presentation) and the detection of a user's command to advance the presentation (e.g., a user selecting to advance the slide) can be used to automatically control invocation of the pause command and of the resume command.

For example, if a presenter is staying on a slide for a long time and there is no other networking traffic being transmitted from the source device, the operating system can be programmed to control the WiFi chip of the source device to go into a low power state. Before doing so, however, a pause until resume command can be sent to the sink device to keep the connection alive.

Still further, in some embodiments, the source device can monitor the network quality or network volume in a room, and when the quality drops below a predetermined threshold (or the volume exceeds a predetermined threshold), the source device can operate in the low-power mode described above to reduce the network congestion (e.g., by ceasing to send unnecessary communication over the network).

C. Example Methods for Performing the “Pause” Functionality

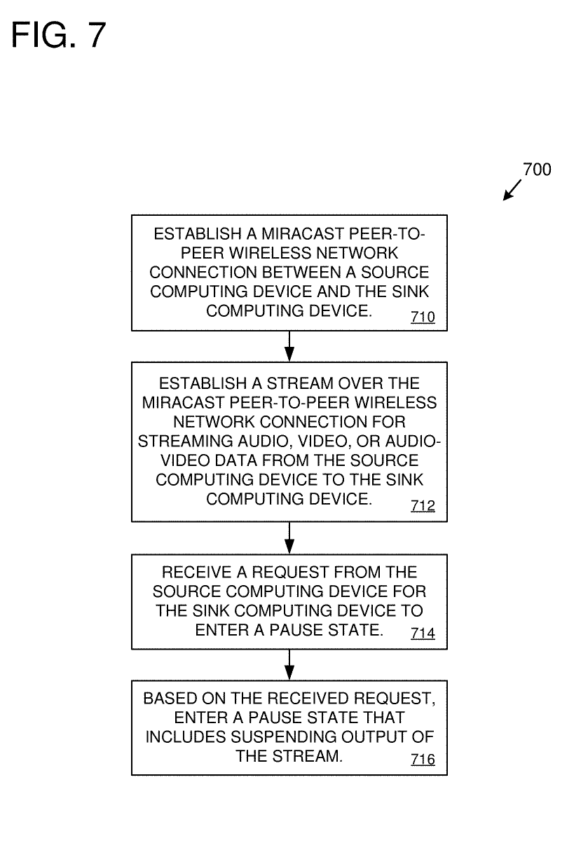

FIG. 7 is a flowchart of an example method 700 for pausing a peer-to-peer presentation (e.g., a Miracast presentation) in accordance with the disclosed technology. The example method 700 is performed by the sink device that receives presentation data from the source device and outputs (e.g., displays video or image data and/or outputs audio data). The particular embodiment should not be construed as limiting, as the disclosed method acts can be performed alone, in different orders, or at least partially simultaneously with one another. Further, any of the disclosed methods or method acts can be performed with any other methods or method acts disclosed herein.

At 710, a peer-to-peer wireless network connection (e.g., a Miracast connection) is established between a source computing device and the sink computing device.

At 712, a stream over the peer-to-peer wireless network connection is established (e.g., a Miracast stream) for streaming audio, video, or audio-video data from the source computing device to the sink computing device.

At 714, a request is received from the source computing device for the sink computing device to enter a pause state.

At 716, based on the received request, the sink device enters a pause state that includes suspending output of the stream. For example, based on the received request, the source device's Miracast endpoint can pause sending a video stream and the sink device can pause refreshing its display endpoint while continuing to display the last frame before the pause.

In particular embodiments, the suspending the output of the stream comprises repeatedly displaying an image that was being presented at the time the pause state was entered. In other embodiments, the suspending the output of the stream comprises halting an audio output of the stream. In still other embodiments, the suspending the output of the stream comprises halting an audio output of the stream and repeatedly displaying an image that was being presented at the time the pause state was entered.

With such pause functionality, a presenter using the source device can pause a presentation and, for instance, answer a phone call or navigate to a file or website without the images or audio from the source being presented at the sink device.

In some embodiments, the method further comprises maintaining the pause state despite the absence of a signal (e.g., packets) from the source computing device to “keep alive” the session with the source computing device. Such embodiments deviate from typical peer-to-peer protocols (e.g., the Miracast standard). In further embodiments, the pause state is maintained despite the source device being moved out of local peer-to-peer communication (e.g., Miracast) range of the sink device. Again, such embodiments deviate from typical peer-to-peer protocols (e.g., the Miracast standard).

In certain embodiments, the request from the source computing device is a request to pause for a user-selected period of time. In such embodiments, the method can further comprise terminating the pause state when the user-selected period of time has expired. In other embodiments, the request from the source computing device is a request to pause until a user of the source computing device selects to resume the stream. In such embodiments, the method can further comprise receiving an instruction to resume the stream from the source computing device; and re-establishing the stream over the Miracast peer-to-peer wireless network connection for streaming audio, video, or audio-video data from the source computing device to the sink computing device.

In some embodiments, the method further comprises receiving an instruction from an administrator's computing device to terminate the session. The pause state can then be terminated in response to the instruction from the administrator's computing device.

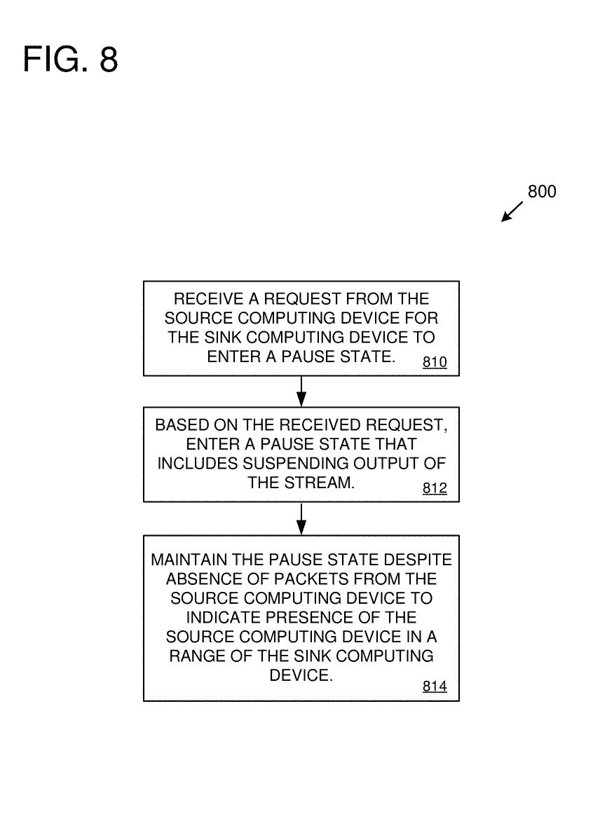

FIG. 8 is a flowchart of an example method 800 for pausing a peer-to-peer communication (e.g., a Miracast presentation) in accordance with the disclosed technology. The example method 700 is performed by the sink device that receives presentation data from the source device and outputs (e.g., displays video or image data and/or outputs audio data). The particular embodiment should not be construed as limiting, as the disclosed method acts can be performed alone, in different orders, or at least partially simultaneously with one another. Further, any of the disclosed methods or method acts can be performed with any other methods or method acts disclosed herein.

At 810, a request is received from a source computing device for the sink computing device to enter a pause state. Further, the request is received during a peer-to-peer wireless communication session (e.g., a Miracast session) in which a stream of media data (audio data, video data, or audio-video data) is transmitted from the source computing device.

At 812, based on the received request, a pause state is entered that includes suspending output of the stream.

At 814, the pause state is maintained despite the absence of any packets coming from the source computing device to indicate the presence of the source computing device in a range of the sink computing device.

In some embodiments, an instruction is received from an administrator's computing device to terminate the session, and the pause state is terminated in response to the instruction from the administrator's computing device.

In certain embodiments, the request from the source computing device is a request to pause for a user-selected period of time, and the method further comprises terminating the pause state when the user-selected period of time has expired. In other embodiments, the request from the source computing device is a request to pause until a user of the source computing device selects to resume the stream, and the method further comprises receiving an instruction to resume the stream from the source computing device; and re-establishing the stream over the peer-to-peer wireless network connection for streaming audio, video, or audio-video data from the source computing device to the sink computing device.

In some embodiments, the request from the source computing device is automatically sent by the source computing device upon detecting that the media data is static at the source computing device.

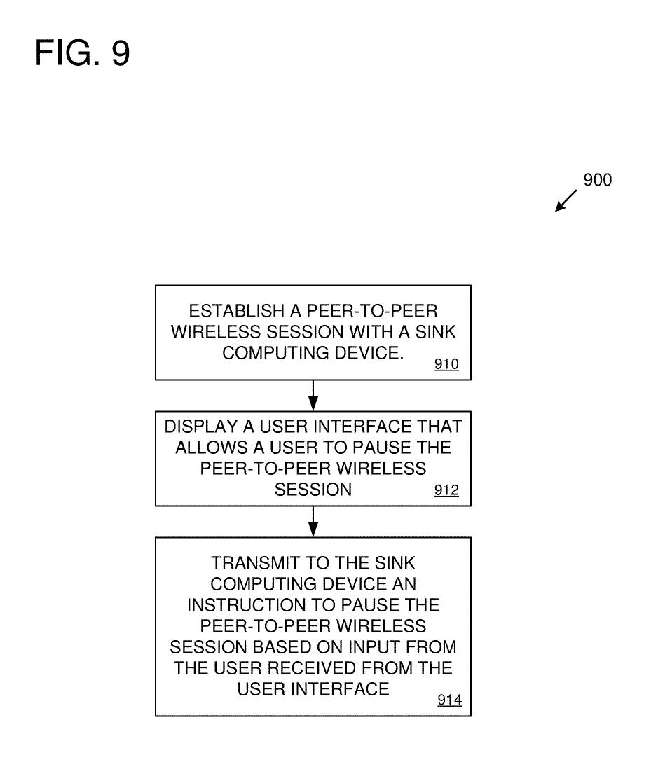

FIG. 9 is a flowchart of an example method 900 for pausing a peer-to-peer wireless presentation (e.g., Miracast presentation) in accordance with the disclosed technology. The example method 900 is performed by the source device that provides presentation data to the sink device (e.g., video data, image data, and/or audio data). The particular embodiment should not be construed as limiting, as the disclosed method acts can be performed alone, in different orders, or at least partially simultaneously with one another. Further, any of the disclosed methods or method acts can be performed with any other methods or method acts disclosed herein.

At 910, a peer-to-peer wireless session is established with a sink computing device.

At 912, a user interface is displayed that allows a user to pause the peer-to-peer wireless session.

At 914, an instruction to pause the peer-to-peer wireless session is transmitted to the sink computing device based on input from the user received from the user interface.

In some embodiments, the peer-to-peer wireless network connection is established using the Miracast standard. In certain embodiments, the user interface allows the user to select an option to pause the peer-to-peer wireless network connection for a period of time, and the processing unit is programmed to receive the period of time selected by the user. In some embodiments, the user interface allows the user to select an option to pause the peer-to-peer wireless network connection until the user elects to resume the session, and the processing unit is programmed to receive a request from the user to resume the peer-to-peer wireless session, and transmit to the sink computing device the request from the user to resume the peer-to-peer wireless session.

In certain embodiments, the source device operates as though the peer-to-peer wireless session is active so long as the session is paused, despite the source device being moved out of peer-to-peer connection (e.g., Miracast) range of the sink device.

Various technical advantages can be realized by implementing the disclosed embodiments of the disclosed technology. For example, the use of the “pause” function can save bandwidth, power, and computational resources during the time in which the function is invoked, as the content data from the source device need not be sent to the sink device. For instance, power can be saved at either or both of the source or sink devices by reducing the unnecessary network payload that would otherwise occur during the pause state. Further, bandwidth and computational resources are saved by allowing for the absence of the “keep alive” signal exchange between the source device and the sink device and/or saving computational resources that would otherwise be necessary to re-establish the peer-to-peer connection if the source device is moved out of range of the sink device and then returned. Still further, embodiments of the disclosed technology can be used to reduce the congestion on a wireless peer-to-peer network (e.g., when high WiFi signal noise is detected when Miracast or any other wireless protocol is being used in a congested room setting to present video or audio).

D. Example Computing Systems

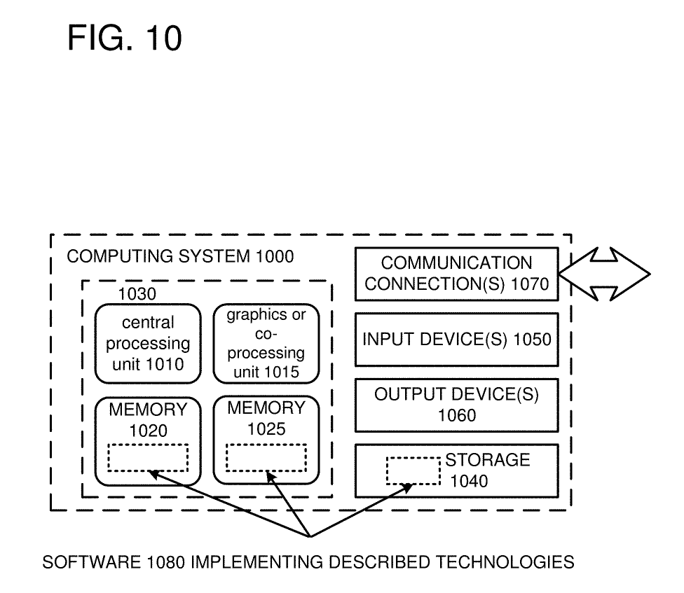

FIG. 10 depicts a generalized example of a suitable computing system 1000 in which the described innovations may be implemented. The computing system 1000 is not intended to suggest any limitation as to scope of use or functionality, as the innovations may be implemented in diverse general-purpose or special-purpose computing systems.

With reference to FIG. 10, the computing system 1000 includes one or more processing units 1010, 1015 and memory 1020, 1025. In FIG. 10, this basic configuration 1030 is included within a dashed line. The processing units 1010, 1015 execute computer-executable instructions. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 10 shows a central processing unit 1010 as well as a graphics processing unit or co-processing unit 1015. The tangible memory 1020, 1025 may be volatile memory (e.g., registers, cache, RAM), non-volatile memory (e.g., ROM, EEPROM, flash memory, etc.), or some combination of the two, accessible by the processing unit(s). The memory 1020, 1025 stores software 1080 implementing one or more innovations described herein, in the form of computer-executable instructions suitable for execution by the processing unit(s).

A computing system may have additional features. For example, the computing system 1000 includes storage 1040, one or more input devices 1050, one or more output devices 1060, and one or more communication connections 1070. An interconnection mechanism (not shown) such as a bus, controller, or network interconnects the components of the computing system 1000. Typically, operating system software (not shown) provides an operating environment for other software executing in the computing system 1000, and coordinates activities of the components of the computing system 1000.

The tangible storage 1040 may be removable or non-removable, and includes magnetic disks, magnetic tapes or cassettes, CD-ROMs, DVDs, or any other medium which can be used to store information and which can be accessed within the computing system 1000. The storage 1040 stores instructions for the software 1080 implementing one or more innovations described herein.

The input device(s) 1050 may be a touch input device such as a keyboard, mouse, pen, or trackball, a voice input device, a scanning device, or another device that provides input to the computing system 1000. For video encoding, the input device(s) 1050 may be a camera, video card, TV tuner card, or similar device that accepts video input in analog or digital form, or a CD-ROM or CD-RW that reads video samples into the computing system 1000. The output device(s) 1060 may be a display, printer, speaker, CD-writer, or another device that provides output from the computing system 1000.

The communication connection(s) 1070 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

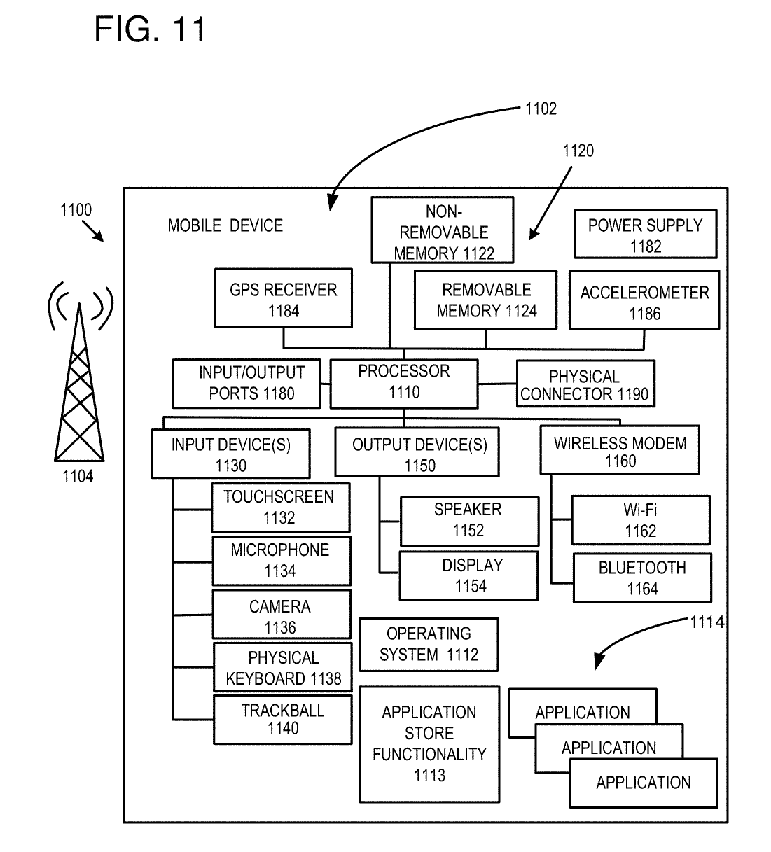

FIG. 11 is a system diagram depicting an example mobile device 1100 including a variety of optional hardware and software components, shown generally at 1102. The example mobile device 1100 can be used, for instance, as the source device to establish a peer-to-peer wireless connection with a sink and perform, at least in part, the pause functionality as described herein. Any components 1102 in the mobile device can communicate with any other component, although not all connections are shown, for ease of illustration. The mobile device can be any of a variety of computing devices (e.g., cell phone, smartphone, handheld computer, Personal Digital Assistant (PDA), etc.) and can allow wireless two-way communications with one or more mobile communications networks 1104, such as a cellular, satellite, or other network.

The illustrated mobile device 1100 can include a controller or processor 1110 (e.g., signal processor, microprocessor, ASIC, or other control and processing logic circuitry) for performing such tasks as signal coding, data processing, input/output processing, power control, and/or other functions. An operating system 1112 can control the allocation and usage of the components 1102 and support for one or more application programs 1114. The application programs can include common mobile computing applications (e.g., email applications, calendars, contact managers, web browsers, messaging applications), or any other computing application. Functionality 1113 for accessing an application store can also be used for acquiring and updating application programs 1114.

The illustrated mobile device 1100 can include memory 1120. Memory 1120 can include non-removable memory 1122 and/or removable memory 1124. The non-removable memory 1122 can include RAM, ROM, flash memory, a hard disk, or other well-known memory storage technologies. The removable memory 1124 can include flash memory or a Subscriber Identity Module (SIM) card, which is well known in GSM communication systems, or other well-known memory storage technologies, such as “smart cards.” The memory 1120 can be used for storing data and/or code for running the operating system 1112 and the applications 1114. Example data can include web pages, text, images, sound files, video data, or other data sets to be sent to and/or received from one or more network servers or other devices via one or more wired or wireless networks. The memory 1120 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 1100 can support one or more input devices 1130, such as a touchscreen 1132, microphone 1134, camera 1136, physical keyboard 1138 and/or trackball 1140 and one or more output devices 1150, such as a speaker 1152 and a display 1154. Other possible output devices (not shown) can include piezoelectric or other haptic output devices. Some devices can serve more than one input/output function. For example, touchscreen 1132 and display 1154 can be combined in a single input/output device.

The input devices 1130 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye , and gaze tracking, immersive augmented reality and virtual reality systems, all of which provide a more natural interface, as well as technologies for sensing brain activity using electric field sensing electrodes (EEG and related methods). Thus, in one specific example, the operating system 1112 or applications 1114 can comprise speech-recognition software as part of a voice user interface that allows a user to operate the device 1100 via voice commands Further, the device 1100 can comprise input devices and software that allows for user interaction via a user's spatial gestures, such as detecting and interpreting gestures to provide input to a gaming application.

A wireless modem 1160 can be coupled to an antenna (not shown) and can support two-way communications between the processor 1110 and external devices, as is well understood in the art. The modem 1160 is shown generically and can include a cellular modem for communicating with the mobile communication network 1104 and/or other radio-based modems (e.g., Bluetooth 1164 or Wi-Fi 1162). The wireless modem 1160 is typically configured for communication with one or more cellular networks, such as a GSM network for data and voice communications within a single cellular network, between cellular networks, or between the mobile device and a public switched telephone network (PSTN).

The mobile device can further include at least one input/output port 1180, a power supply 1182, a satellite navigation system receiver 1184, such as a Global Positioning System (GPS) receiver, an accelerometer 1186, and/or a physical connector 1190, which can be a USB port, IEEE 1394 (FireWire) port, and/or RS-232 port. The illustrated components 1102 are not required or all-inclusive, as any components can be deleted and other components can be added.

Any of the disclosed methods can be implemented as computer-executable instructions or a computer program product stored on one or more computer-readable storage media and executed on a computing device (any available computing device, including smart phones or other mobile devices that include computing hardware). Computer-readable storage media are tangible media that can be accessed within a computing environment (one or more optical media discs such as DVD or CD, volatile memory (such as DRAM or SRAM), or nonvolatile memory (such as flash memory or hard drives)). By way of example and with reference to FIG. 10, computer-readable storage media include memory 1020 and 1025, and storage 1040. By way of example and with reference to FIG. 11, computer-readable storage media include memory and storage 1120, 1122, and 1124. The term computer-readable storage media does not include signals and carrier waves. In addition, the term computer-readable storage media does not include communication connections, such as 1070, 1160, 1162, and 1164.

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

### III. Concluding Remarks

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology.

What is claimed is:

1. A method, implemented by a sink computing device in a peer-to-peer wireless network connection, the method comprising:
establishing a Miracast peer-to-peer wireless network connection between a source computing device and the sink computing device;
establishing a stream over the Miracast peer-to-peer wireless network connection for streaming audio, video, or audio-video data from the source computing device to the sink computing device;
receiving a request from the source computing device for the sink computing device to enter a pause state; and
based on the received request, entering a pause state that includes suspending output of the stream.

2. The method of claim 1, wherein the suspending the output of the stream comprises repeatedly displaying an image being presented at a time of the pause state being entered.

3. The method of claim 1, wherein the suspending the output of the stream comprises halting audio output of the stream.

4. The method of claim 1, wherein the request from the source computing device is a request to pause for a user-selected period of time.

5. The method of claim 4, further comprising terminating the pause state when the user-selected period of time has expired.

6. The method of claim 1, wherein the request from the source computing device is a request to pause until a user of the source computing device selects to resume the stream.

7. The method of claim 6, further comprising:
receiving an instruction to resume the stream from the source computing device; and
re-establishing the stream over the Miracast peer-to-peer wireless network connection for streaming audio, video, or audio-video data from the source computing device to the sink computing device.

8. The method of claim 1, further comprising maintaining the pause state despite absence of a signal from the source computing device to keep alive the session with the source computing device.

9. The method of claim 1, further comprising:
receiving an instruction from an administrator's computing device to terminate the session; and
terminating the pause state in response to the instruction from the administrator's computing device.

10. The method of claim 1, wherein the pause state is maintained despite the source device being moved out of Miracast range of the sink device.

11. One or more computer-readable media storing computer-executable instructions, which when executed by a computing device causes the computer to perform a method, the method comprising:
during a Miracast peer-to-peer wireless communication session in which a stream of media data is transmitted from a source computing device, receiving a request from the source computing device for the sink computing device to enter a pause state;
based on the received request, entering a pause state that includes suspending output of the stream; and
maintaining the pause state despite absence of any packets coming from the source computing device to indicate presence of the source computing device in a range of the sink computing device.

12. The one or more computer-readable media of claim 11, wherein the method further comprises:
receiving an instruction from an administrator's computing device to terminate the pause state; and
terminating the pause state in response to the instruction from the administrator's computing device.

13. The one or more computer-readable media of claim 11, wherein the request from the source computing device is a request to pause for a user-selected period of time, and wherein the method further comprises terminating the pause state when the user-selected period of time has expired.

14. The one or more computer-readable media of claim 11, wherein the request from the source computing device is a request to pause until a user of the source computing device selects to resume the stream, and wherein the method further comprises:
receiving an instruction to resume the stream from the source computing device; and
re-establishing the stream over the peer-to-peer wireless network connection for streaming audio, video, or audio-video data from the source computing device to the sink computing device.

15. The one or more computer-readable media of claim 11, wherein the request from the source computing device is automatically sent by the source computing device upon detecting that the media data is static at the source computing device.

16. A system, comprising:
a processing unit; and
a memory;
the processing unit being programmed to:
establish a peer-to-peer wireless session with a sink computing device;
display a user interface that allows a user to pause the peer-to-peer wireless session; and
transmit to the sink computing device an instruction to pause the peer-to-peer wireless session based on input from the user received from the user interface.

17. The system of claim 16, wherein the peer-to-peer wireless network connection is established using the Miracast standard.

18. The system of claim 16, wherein the user interface allows the user to select an option to pause the peer-to-peer wireless network connection for a period of time, and wherein the processing unit is programmed to receive the period of time selected by the user.

19. The system of claim 16, wherein the user interface allows the user to select an option to pause the peer-to-peer wireless network connection until the user elects to resume the session, and wherein the processing unit is programmed to:
receive a request from the user to resume the peer-to-peer wireless session; and
transmit to the sink computing device the request from the user to resume the peer-to-peer wireless session.

20. The system of claim 16, wherein the source device operates as though the peer-to-peer wireless session is active so long as the session is paused despite the source device being moved out of range of the sink device.
